(19) United States
(12) Patent Application Publication
(10) Pub. No.: US 2006/0261666 A1
(43) Pub. Date: Nov. 23, 2006

(54) Spoke for a bicycle wheel and bicycle wheel comprising such a spoke

(75) Inventor: Maurizio Passarotto, Rovigo (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.I., Vicenza (IT)

(21) Appl. No.: 11/435,175

(22) Filed: May 16, 2006

(30) Foreign Application Priority Data
May 16, 2005 (EP) 05425328.1

(51) Int. Cl. B60B 1/00

(52) U.S. Cl. 301/104

(57) ABSTRACT

A spoke (10) for a bicycle wheel comprising an elongated body (20) extending along a longitudinal axis (X-X) The elongated body has a first end portion (30) for attachment to a hub (100) of a bicycle wheel (400), a second end portion (40) for attachment to a rim (402) of the bicycle wheel and a portion (60) flattened in a transversal direction (Z) perpendicular to the longitudinal axis (X-X). At least one of the spoke end portions has a surface of revolution which includes at least one discontinuity and mates with a corresponding hub or rim discontinuity. The mated discontinuities prevent rotation of the mounted spoke about its axis, X-X, and the correct position is maintained during travel even following knocks or vibrations.

### FIELD OF INVENTION

The present invention generally relates to a spoke for a bicycle wheel. More particularly, the invention relates to a spoke which has a flattened portion and a geometric discontinuity that orients the flattened portion of the spoke in a desired position of use. The invention most particularly relates to a bicycle wheel comprising a plurality of such spokes.

As known, spokes for a bicycle wheel comprise an elongated body, generally made from metal like steel or aluminum or alloys thereof, provided with a first end for attachment to the hub and a second end for attachment to the rim on which the tire is mounted. Typically, the end for attachment to the hub is shaped so as to define a head intended to be housed in suitable seat and/or opening formed in the hub; the end for attachment to the rim, on the other hand, typically has a threaded zone to allow the attachment to the rim and the adjustment of the tension of the spoke through the application of a suitable nut or nipple.

In order to enhance the aesthetics appearance and the sports performance of the wheels, as well as the safety and comfort of the cyclist, flattened spokes have been proposed, i.e. spokes having a flattened body portion between the two ends. The flattened spokes, if correctly orientated when mounted onto the hub and rim, give the wheel an original aesthetic appearance and allow the visibility and aerodynamics of the wheel itself to be increased, at the same time reducing its noisiness during travel.

### BACKGROUND

Some known spokes comprise a substantially cylindrical wire-shaped element having a frusto-conical head for attachment to the hub, a threaded end for attachment to the rim and a cylindrical intermediate portion having a flattened zone at the crossing zones of the spokes when mounted on the wheel. The head for attachment to the hub is intended to be housed in a seat formed on the side surface of the hub; such a seat is open at the front surface of the hub.

### SUMMARY OF INVENTION

The present invention relates to a bicycle spoke comprising an elongated body extending along a longitudinal axis X-X. The elongated spoke body has a first end that includes a portion for attachment to a bicycle wheel hub, a second end that includes a portion for attachment to a bicycle wheel rim and an intermediate portion, between said first and second ends, that includes a portion flattened in a direction Z perpendicular to said longitudinal axis X-X. At least one of the end portions includes a surface discontinuity that mates with a hub or rim discontinuity to preserve said flattened portion of said spoke in a desired orientation during assembly and use.

### BRIEF DESCRIPTION OF THE DRAWINGS

Further characteristics and advantages of the present invention shall become clearer from the following detailed descriptions of preferred embodiments which are made with reference to the attached drawings. In such drawings:

FIG. 1 is a perspective view of a section of a spoke according to one embodiment of the present invention;

FIG. 2 is a perspective view of a section of a spoke according to another embodiment of the present invention;

FIG. 3 is a fragmentary view of a first hub of a bicycle wheel associated with one spoke as illustrated in FIG. 2;

FIG. 4 is a fragmentary view a second hub of a bicycle wheel associated with one spoke as illustrated in FIG. 2;

FIG. 5 is a perspective view of a section of another embodiment of a spoke in accordance with the present invention;

FIG. 6 is a fragmentary view of the hub of FIG. 2 associated with another embodiment of a spoke in accordance with the present invention;

FIGS. 7 through 11 are perspective views of various embodiments of spokes having geometric or surface discontinuities in accordance with the present invention;

FIG. 12 is an elevation illustrating another embodiment of a spoke in accordance with the present invention;

FIG. 13 is an enlarged sectional view detailing the interface between the seat and the geometric discontinuity of the spoke of FIG. 12;

FIG. 14 is a top plan view of the spoke of FIG. 12;

FIG. 15 is an exploded perspective view of another embodiment of a spoke according to the present invention;

FIG. 16 is an exploded perspective view of another embodiment of a spoke according to the present invention; and,

FIG. 17 is an elevation view of an assembled wheel having spokes according to the present invention.

### DETAILED DESCRIPTION OF THE PREFERRED EMBODIMENT(S)

Throughout the present description and the subsequent claims, the expression: flattened portion means a portion that has been worked along the transversal direction Z so that the cross section of such a flattened portion is of a size in one dimension that is substantially smaller than the other dimension. The opposite faces of the flattened portion do not have to be perfectly flat and parallel; i.e. the faces can have an elliptical or ovate progression with a wide bending radius.

Throughout the descriptions and claims, the expression, “surface of revolution,” indicates a surface oriented about and rotatable about an axis when the surface is in abutment with a corresponding coupling surface of another body. For example, a surface of revolution can be cylindrical, spherical, parabolic, toroidal, concave, convex, etc.

Providing a geometric or surface discontinuity in the surface of revolution defines a univocal coupling position between a spoke and a seat in the other body, thus preventing the relative rotation of the spoke with respect to the hub or rim. In particular, the rotation of the spoke about its longitudinal axis is prevented by the abutment action of the aforementioned discontinuity against the abutment surface. Therefore, the correct orientation of the flattened portion of the spoke is ensured in the assembly step of the wheel and it is ensured that such correct orientation is maintained during travel, even following knocks or vibrations and/or under conditions of improper tension that involve a loss of abutment tension.

The spoke of the present invention is suitable for being associated with conventional hubs in which the seats are formed on the side surface and are open at the front and with conventional hubs in which the seats are formed on the side surface and are closed at the front. In some cases, it may be necessary to modify the seat to make the abutment surface for the discontinuity; however, this is a minor and inexpensive modification that does not alter the original functionality of the hub.

A particularly advantageous aspect of the spoke of the present invention is the possibility of obtaining the benefits of the aforementioned spoke without the need for added steps in the conventional spoke production process. For example, it is possible to modify the mould or die for the manufacturing of the spoke head shape to obtain the desired discontinuity. Any additional cost of manufacturing the spoke of the present invention should therefore be relatively low.

For the sake of simplicity, throughout the present description reference shall often be made to the coupling between spoke and hub. Those skilled in the art will understand that there is an analogous application to the coupling between spoke and rim.

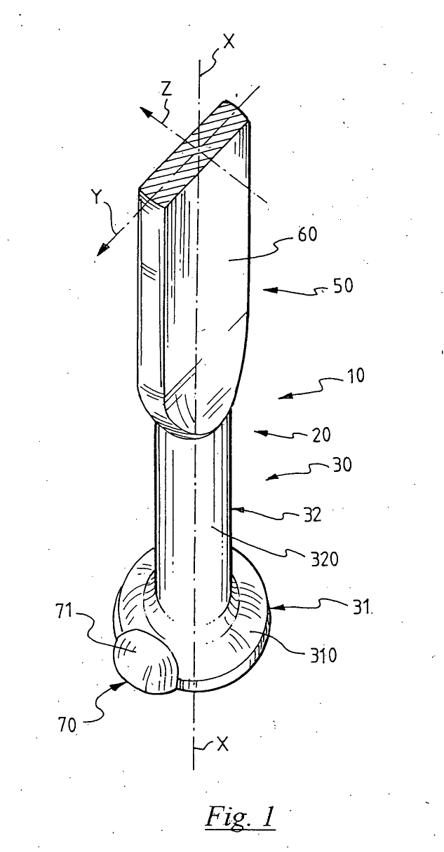

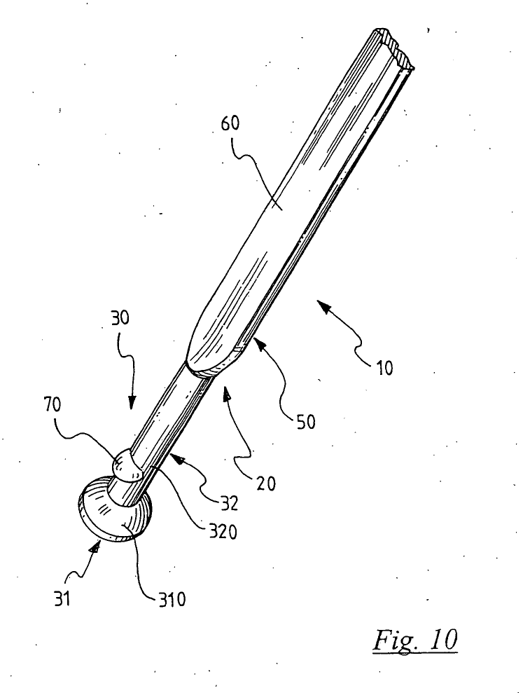

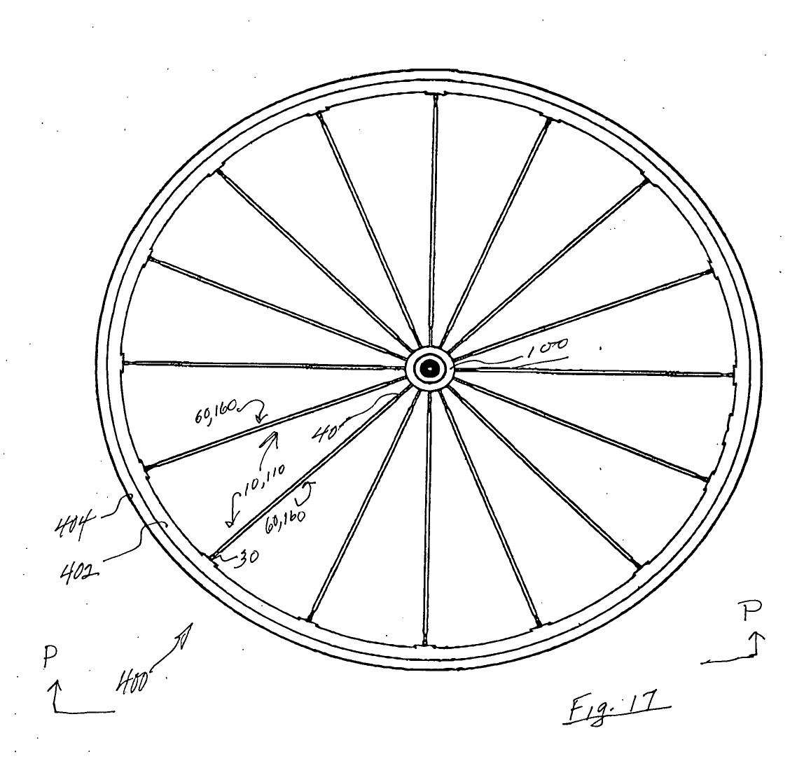

In the attached figures, a spoke for bicycle wheels in accordance with the present invention is indicated generally as 10. The spoke 10 comprises an elongated body 20, preferably made from metal like steel or aluminum or alloys thereof (for example aluminum alloy), extending along a longitudinal axis X-X. Such a type of spoke is intended to be used in a bicycle wheel, see FIG. 17, in which the spoke is connected between a hub 100 to a rim 400 on which a tire 402 is mounted. As shown in FIG. 12, the body 20 of the spoke 10 of the present invention comprises a first end portion 30 for attachment to the hub, a second end portion 40, typically threaded, defining a zone for attachment to the rim through a tensioning nipple 41 and an intermediate portion 50. The intermediate portion 50 of spoke 10 has a portion 60 flattened in a transversal direction Z perpendicular to the longitudinal axis X-X of the spoke 10. See in particular FIGS. 1, 2, 5, and 7-16.

The portion for attachment to the hub 100 comprises, in particular, an end 32 having a head 31 for attachment to the hub 100. The head 31 comprises a substantially frusto-conical surface of revolution 310 that extends from the base surface 33 up to the body end portion 32. Here, the end 32 adjacent to the head 31 is defined by a substantially cylindrical surface of revolution 320 that joins to the flattened portion 60.

In accordance with the present invention, the surface of revolution 310 of the head 31 includes a geometric or surface discontinuity that prevents the rotation of the spoke 10 about its longitudinal axis X-X both during travel and during the assembly and/or tensioning steps of the spoke itself, as shall be described more fully hereafter.

In the embodiment of the spoke of the present invention illustrated in FIG. 1, the aforementioned discontinuity is defined by a projection 70 that extends along a direction Y substantially perpendicular to the direction Z. In particular, the projection 70 is an integrally formed discontinuity on the surface of revolution 310 that has a curved outer surface 71.

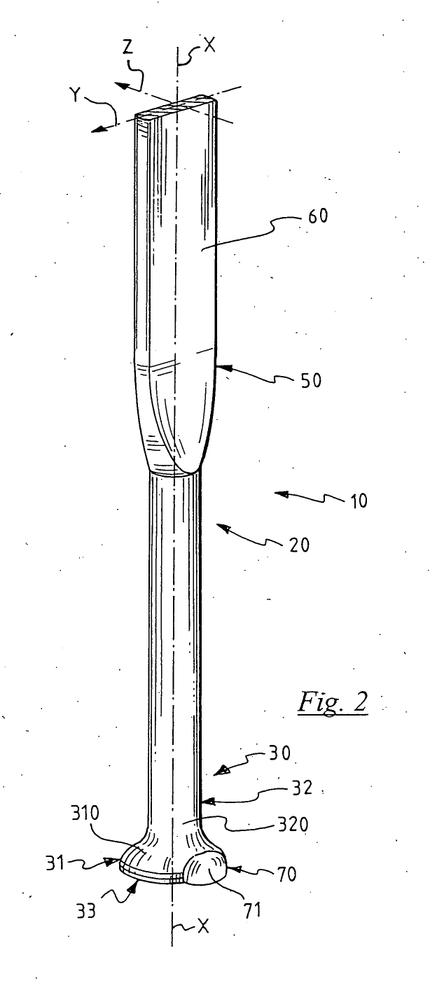

As illustrated in FIG. 2, which shows an alternative embodiment of the spoke of the present invention, the projection 70 may extend from the surface of revolution 310 of the head 31 of the spoke 10 along the direction Z. From this, it can be seen that the projection 70 may extend along a direction different to the directions Y and Z so long as it is located to position the flattened surface 60 in the proper orientation with reference to the X axis.

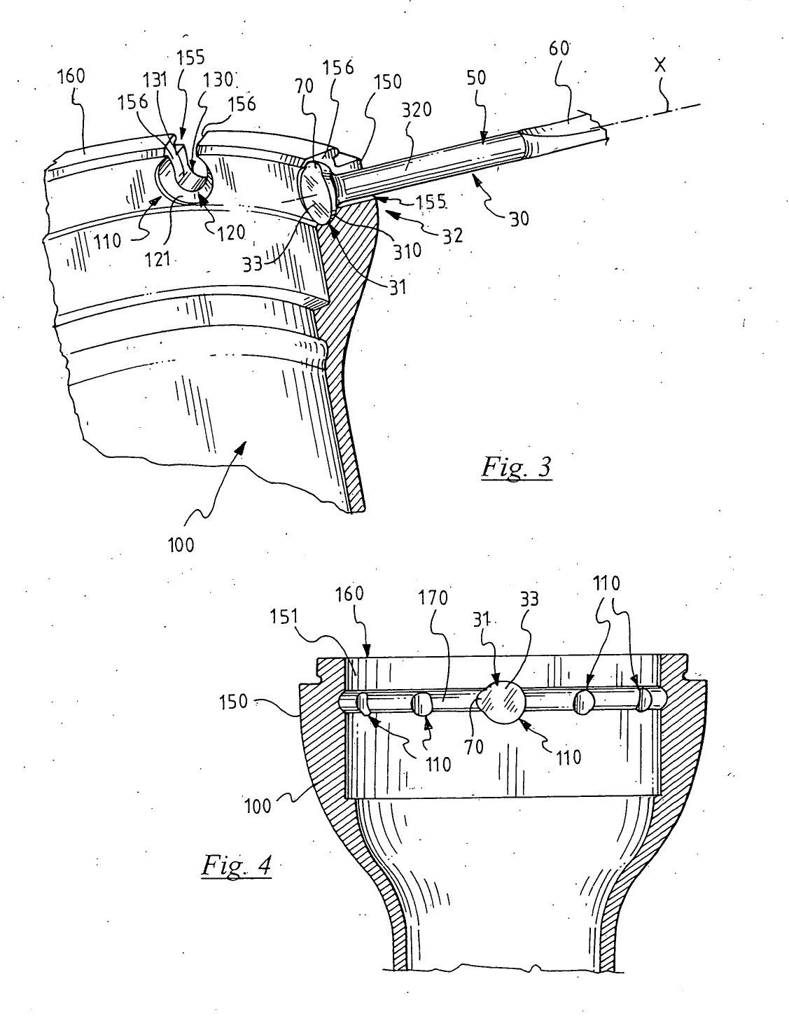

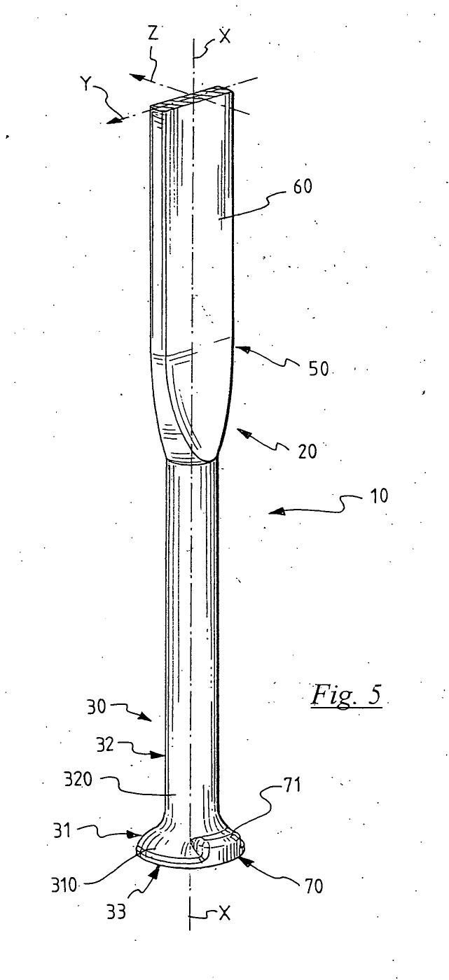

As illustrated in FIGS. 3 and 4, the spoke 10 of the present invention is mounted on the hub 100 at respective housing seats 110 formed on the hub 100. In the embodiment of the hub 100 illustrated in FIG. 3, the seats 110 are formed on a side surface 150 of the hub 100 and have respective openings 155 on the front surface 160 of the hub 100. Such openings 155 are defined by opposite substantially flat side surfaces 156. In the embodiment illustrated in FIG. 4, the seats 110 are formed on the side surface 160 of the hub 100 and are closed at the front thereof.

The seats 110 comprise a first housing portion 120 for the head 31 of the spoke 10 and a second housing portion 130 for passage of the spoke body end 32 adjacent to the head 31 (see FIG. 3). The first housing portion 120 of the seat 110 comprises a convex surface 121 of a shape matching that of the surface of revolution 310 of the head 31 of the spoke 10. In the same way, the second housing portion 130 comprises a surface 131 of a shape matching that of the surface of revolution 320 of the end 32 adjacent to the head 31 of the spoke 10.

Still with reference to the embodiment of the hub 100 illustrated in FIG. 3, the spoke 10 is mounted in the seats 110 of the hub 100 inserting it through the openings 155 formed on the front surface 160 of the hub 100 and is positioned in such a way that, once tensioned, the surface of revolution 310 of the head 31 is in abutment against the surface 121 of the first housing portion 120 of the seat 110 and the projection 70 is at least partially housed in the front opening 155 of the seat. The rotation of the spoke 10 about its longitudinal axis X-X is prevented by the abutment action of the projection 70 against the walls 156 that define the opening 155. Thus, the Z direction will generally follow the rotation of the wheel 400.

In the embodiment of the hub 100 illustrated in FIG. 4, the spoke 10 is mounted in the seats 110 of the hub 100 making it run through the seats 110.

In this case, the spoke 10 is positioned in such a way that both the surface of revolution 310 of the head 31 and the projection 70 partially project in a trough or groove 170 formed circumferentially on the inner side surface 151 of the hub 100 at the seats 110. The rotation of the spoke 10 about its longitudinal axis X-X is thus prevented by the abutment action of the projection 70 against the inner side surface 151 of the hub at the throat or groove 170. It will be appreciated that the hub of FIG. 4 would multiple, and preferably, each seat 110 prepared with a respective throat for housing the projection 70 of the respective spoke

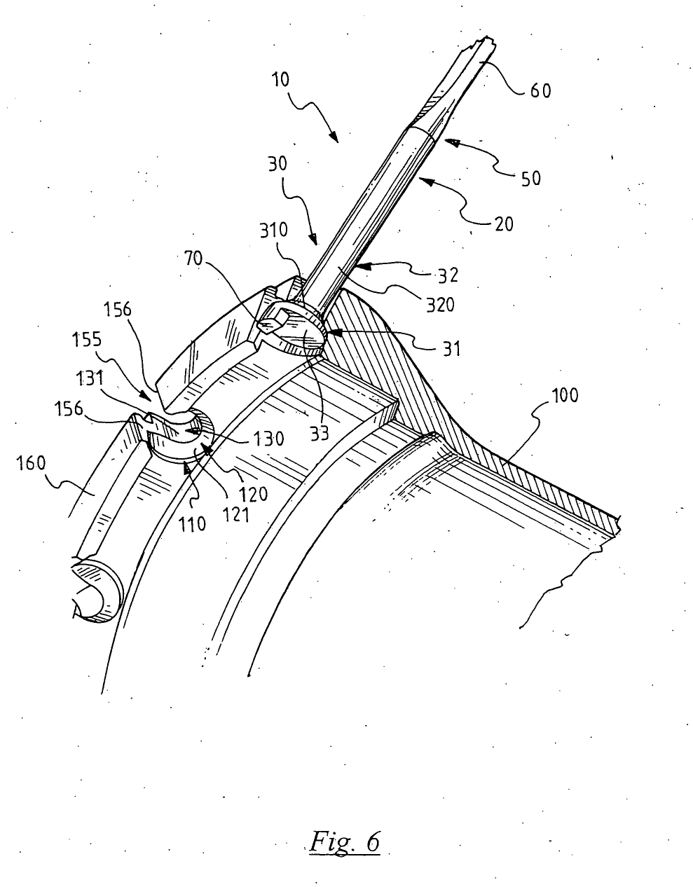

Further alternative embodiments of the spoke of the present invention are illustrated in FIGS. 5 to 11. One skilled in the art shall, however, understand that it is possible to imagine and manufacture different embodiments to those illustrated and/or described here still applying the same inventive concept, which is that of providing a discontinuity or irregularity in the surface of revolution to interrupt the symmetry of revolution of such a surface were it to have a continuous uninterrupted geometry. The man skilled in the art shall also be able to evaluate, according to the specific embodiment of the spoke considered, whether and what possible modifications it is necessary to make to the hub so as to make it suitable for coupling with the spoke under consideration.

The embodiment illustrated in FIG. 5 differs from the one illustrated in FIG. 2 by reason of the projection 70 extending from the surface of revolution 310 within the perimeter defined by the base 33.

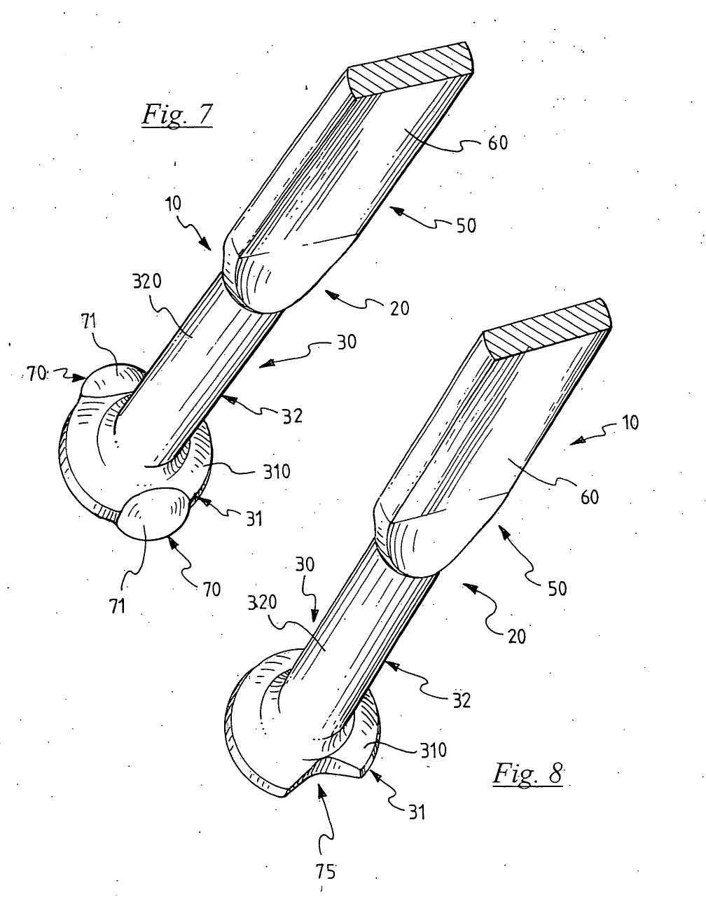

In an alternative embodiment illustrated in FIG. 6, the projection 70 depends from the base 33 of the head 31 and is configured to be confined by the walls 156 that define the opening 155.

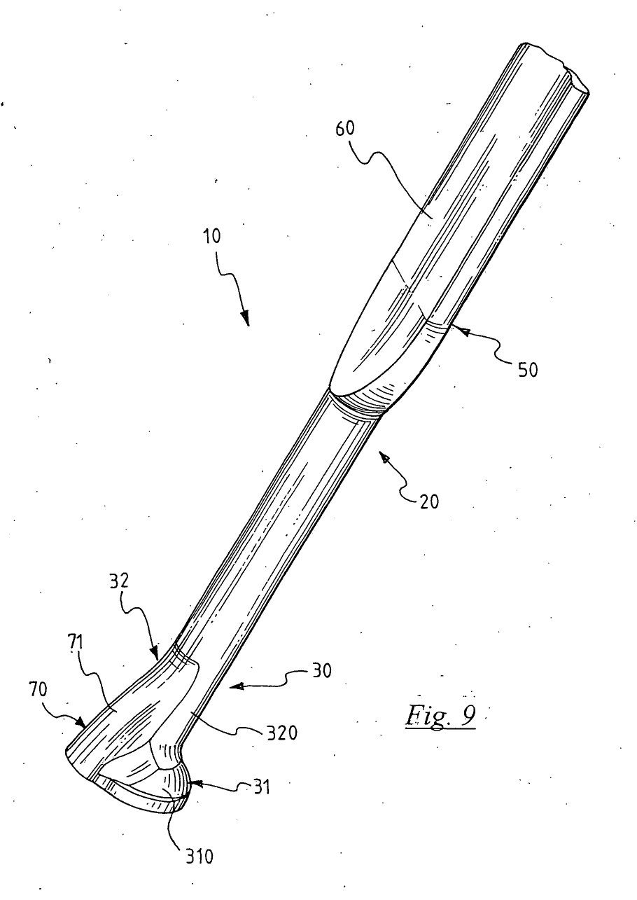

The embodiment illustrated in FIG. 7 differs from those illustrated in FIG. 1 and 2 by reason of having two projections 71 arranged symmetrically with respect to the longitudinal axis X-X of the spoke 10.

The embodiment illustrated in FIG. 8 differs from the prior embodiments by reason of the geometric or surface discontinuity, instead of being defined by a projection, being defined by a recess 75. In such an embodiment, the recess 75 is to be coupled with a suitable projection, such as a tooth or wedge, in the associated seat 110.

In the embodiment illustrated in FIG. 9, the geometric discontinuity 71 projects or extends out and up from the head 31 to form a discontinuity on part of the body of end 32.

In the embodiment illustrated in FIG. 10, the discontinuity is the projection 70 defined on the surface of revolution 320 of the end 32. In this configuration, the discontinuity is adjacent to, but not connected to the head 31 of the spoke 10.

In the embodiment of FIG. 11, the discontinuity on the surface of revolution 310 of the head 31 (or on the surface of revolution 320 of the body portion 32 adjacent to the head 31) is defined by a substantially flat surface configured for abutment with a corresponding substantially flat surface. As illustrated in FIG. 11, the spoke 10 has a head 31 defined by a substantially conical upper portion 310a and a substantially quadrangular lower portion 310b. The lower portion 310b as shown has four facets defining four flat surfaces 311, each arranged perpendicular to the adjacent surface.

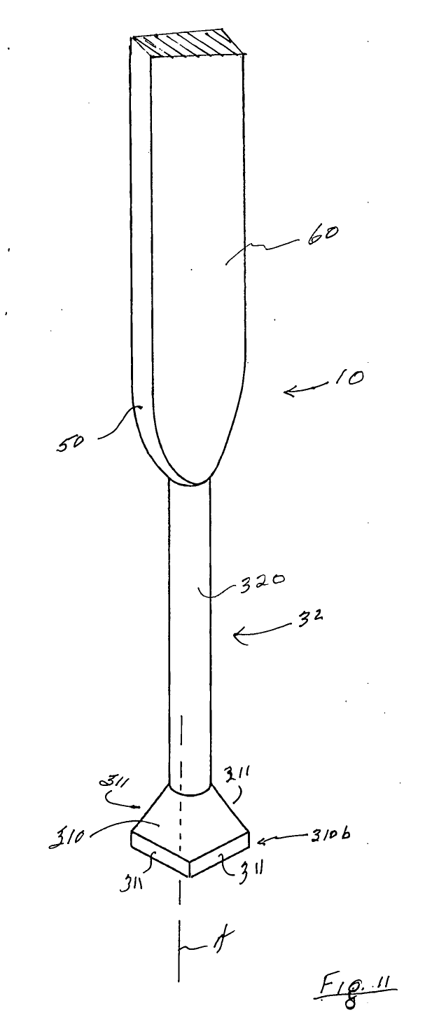

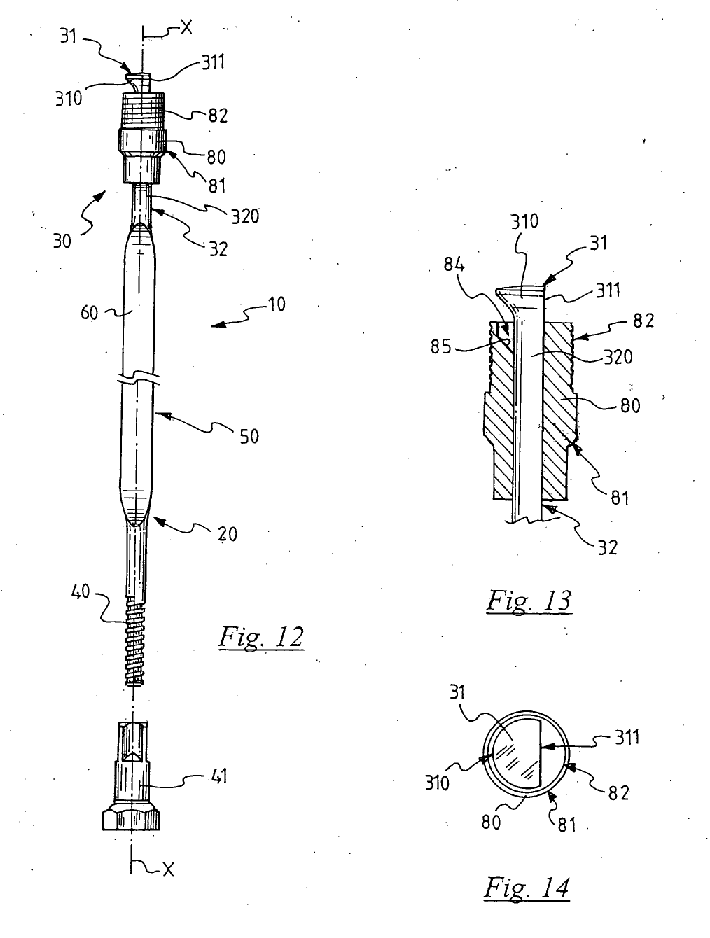

The embodiment illustrated in FIG. 12 differs from those previously described in the arrangement of the geometric discontinuity. In the illustrated example, the discontinuities is defined by the flat surface 311, extending parallel to the longitudinal axis X-X and substantially flush with the surface of rotation 320, adjacent to the head 31, see FIGS. 13 and 14. The bushing or threaded sleeve 80 comprises a longitudinal bore 84, defined by an inner surface 85, matching that of the end portion 30 that fits onto the end 32 of the spoke 10.

In use, the head 31, when fully inserted into the bushing 80, comes into abutment against the inner surface 85. The thusly arranged spoke 10 is then associated with the hub 100 by screwing the male threads 82 into a corresponding female threads in the respective housing seat 110.

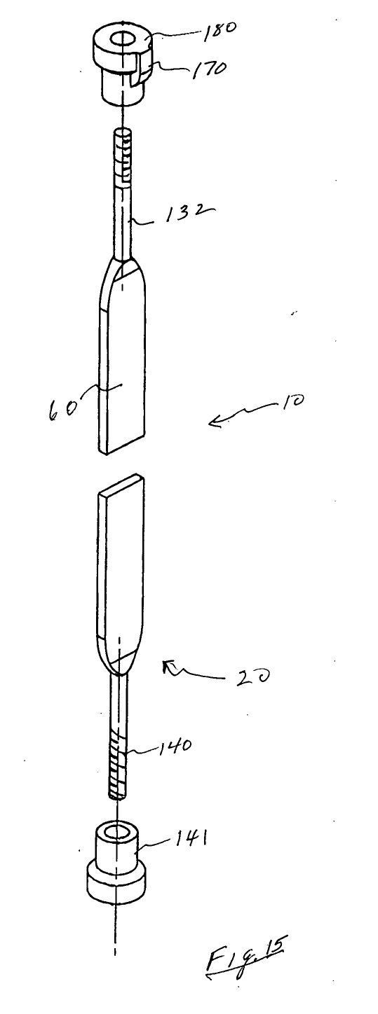

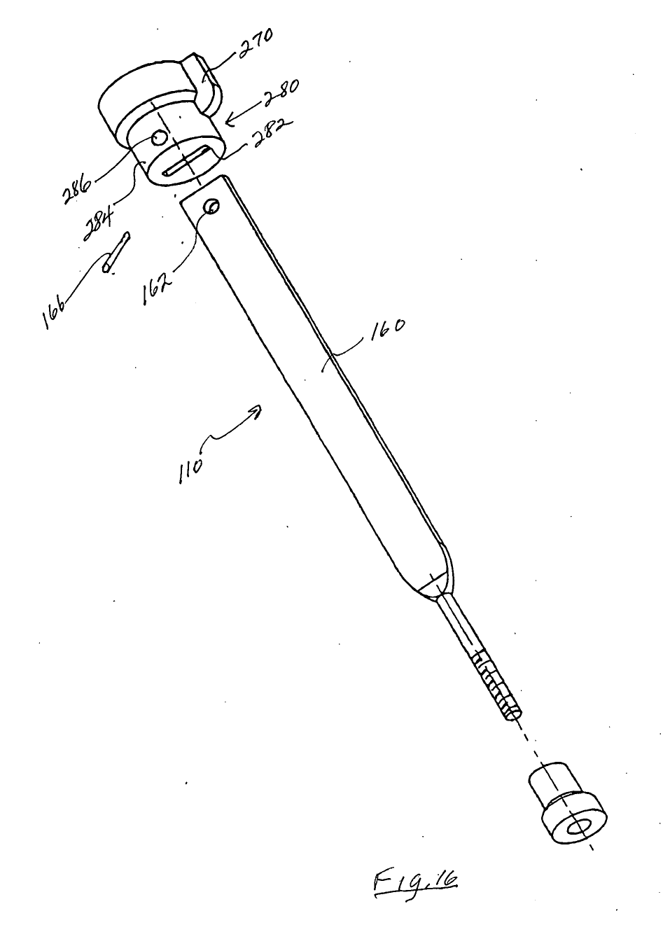

In FIGS. 15 and 16, variants of the spoke of the present invention, the aforementioned surface of revolution, instead of being made directly on the end portion of the elongated body 20 of the spoke 10, is on a separate element. In FIG. 15, which is similar to FIG. 12, the discontinuity is on the surface of the bushing or nut 180. In this configuration, the projection 170 is mated with the corresponding recess in the associated seat, see FIGS. 13 and 14. In FIG. 16, the flattened portion 160 of spoke 110 extends through the length of the top of the spoke 110 and a through aperture 162 is provided adjacent to the free end of spoke 110. The free end of spoke 110 is configured to fit within the slot 282 of sleeve 280 which is formed in the dependent or lower portion 284. Lower portion 284 also includes an aperture 286 dimensioned to be matable with through aperture 162 and receive pin 166. Sleeve 280 is assembled to spoke 110 by aligning the apertures and inserting pin 166. Once assembled, the spoke 110 can be positioned by aligning projection 270 with the corresponding recess in the respective location, see FIGS. 13 and 14.

Referring now to FIG. 17, there is shown an assembled wheel 400 having a hub 100, a plurality of spokes connected between the hub 100 and the rim 402, on which a tire 404 is mounted. The spokes are secured at the ends thereof, 30 and 40 so that the rim is positioned at the desired distance and the spokes 10 and 110 are aligned with the flattened surfaces 60 and 160 generally oriented perpendicularly to a plane P-P which includes the vertical face of the wheel 400.

Preferably, the discontinuities according to the present invention is presented as a curved surface. Advantageously, that a curved surface mates with or couples in abutment with a correspondingly curved surface for retaining the head in the respective seat both during the assembly step and following displacements caused during travel by knocks or vibrations.

What is claimed is:

1. Spoke (10, 110) for a bicycle wheel (400), comprising an elongated body (20) extending along a longitudinal axis (X-X), said spoke (10, 110) comprising:
first and second end portions (30, 40) for respective attachment to a hub (100) and rim (402) of a bicycle wheel (400) wherein at least one of said first and second end portions (30, 40) includes a surface of revolution (310, 320) having at least one discontinuity (70, 75, 311); and
a flattened intermediate portion (60, 160) positioned between said first and second end portions and oriented in a direction (Z) that is generally perpendicular to said longitudinal axis (X-X).

2. Spoke (10) according to claim 1, wherein said at least one of said first and second end portions (30, 40) comprises a head (31) for attachment to the hub (100) and/or rim and an elongated body portion (32) adjacent to said head (31) for attachment to the hub (100) and/or rim, wherein said surface of revolution (310, 320) is defined on said head (31) for attachment to the hub and/or rim.

3. Spoke (10) according to claim 2, wherein said surface of revolution (310, 320) is a frusto-conical surface.

4. Spoke (10) according to claim 1, wherein said at least one of said first and second end portions (30, 40) comprises a head (31) for attachment to the hub (100) and/or rim and an elongated body portion (32) adjacent to said head (31) for attachment to the hub (100) and/or rim, wherein said surface of revolution (310, 320) is defined on said elongated body portion (32) adjacent to said head (31) for attachment to the hub (100) and/or rim.

5. Spoke (10) according to claim 4, wherein said surface of revolution (310, 320) is a cylindrical surface.

6. Spoke (10) according to claim 1, wherein said at least one of said first and second end portions (30, 40) comprises a head (31) for attachment to the hub (100) and/or rim and an elongated body portion (32) adjacent to said head (31) for attachment to the hub (100) and/or rim, wherein said at least one discontinuity (70, 75, 311) extends at least partially on said head (31) for attachment to the hub (100) and/or rim and on said elongated body portion (32) adjacent to said head (31) for attachment to the hub (100) and/or rim.

7. Spoke (10) according to claim 1, wherein said at least one discontinuity comprises at least one projection (70).

8. Spoke (10) according to claim 7, wherein said at least one projection (70) is integrally formed on said surface of revolution (310, 320).

9. Spoke (10) according to claim 7, wherein said at least one projection (70) is defined on an element distinct from and associated with said surface of revolution (310, 320).

10. Spoke (10) according to claim 1, wherein said at least one discontinuity comprises at least one recess (75).

11. Spoke (10) according to claim 1, wherein said at least one discontinuity is defined by a substantially flat surface (311).

12. Spoke (10) according to claim 1, wherein said at least one discontinuity (70, 75, 311) extends along a direction substantially perpendicular to said longitudinal axis (X-X).

13. Spoke (10) according to claim 12, wherein said at least one discontinuity (70, 75, and 311) extends along said direction (Z).

14. Spoke (10) according to claim 13, wherein said at least one discontinuity (70, 75, and 311) extends symmetrically with respect to a plane passing through said longitudinal axis (X-X).

15. Spoke (10) according to claim 12, wherein said at least one discontinuity (70, 75, and 311) extends along a direction (Y) substantially perpendicular to said direction (Z).

16. Spoke (10) according to claim 15, wherein said at least one discontinuity (70, 75, and 311) extends symmetrically with respect to a plane passing through said longitudinal axis (X-X).

17. Spoke (10) according to claim 1, wherein said at least one discontinuity (70, 75, 311) extends from said at least one of said first and second end portions (30, 40) along a direction parallel to said longitudinal axis (X-X).

18. Spoke (10) according to claim 1, wherein said surface of revolution (310, 320) comprises at least two discontinuities (70, 75, 311).

19. Spoke (10) according to claim 18, wherein said surface of revolution (310, 320) comprises four discontinuities (70, 75, 311).

20. Spoke (10) according to claim 19, wherein said discontinuities (70, 75, 311) extend symmetrically with respect to said longitudinal axis (X-X).

21. Spoke (10) according to claim 18, wherein said discontinuities (70, 75, 311) extend symmetrically with respect to said longitudinal axis (X-X).

22. Spoke (10) according to claim 1, wherein said at least one discontinuity (70, 75, 311) comprises a curved outer surface (71).

23. Spoke (10) according to claim 1, wherein said surface of revolution (310, 320) is defined on said first end portion (30).

24. Spoke (10) according to claim 1, wherein said surface of revolution (310, 320) is defined on said second end portion (40).

25. Spoke (10) according to claim 1, further comprising a bush (80) having an outer surface (81) for connection to the hub (100) and/or rim and an inner surface (85) for coupling with said at least one of said first and second end portions (30, 40), wherein said inner surface (85) is at least partially of a shape matching that of said surface of revolution (310, 320).

26. Spoke (10) according to claim 25, wherein said outer surface (81) comprises a threading (82).

27. Bicycle wheel, comprising:
a hub (100);
a rim (402);
a plurality of spokes (10, 110) extending between said hub (100) and said rim (402); each spoke of said plurality of spokes comprises an elongated body (20) extending along a longitudinal axis (X-X), said elongated body (20) having a first end portion (30) for attachment to a hub of a bicycle wheel and a second end portion (40) for attachment to a rim of a bicycle wheel (400) with at least one of said first and second end portions (30, 40) having a surface of revolution (310, 320) that includes a discontinuity; and an flattened intermediate portion (60) oriented in a direction (Z) generally perpendicular to said longitudinal axis (X-X).

28. Wheel according to claim 27, wherein at least one of said hub (100) and said rim comprises at least one coupling surface (85) with said at least one discontinuity (70, 75, and 311).

29. Wheel according to claim 28, wherein said coupling surface (85) is at least partially of a shape matching that of said at least one discontinuity (70, 75, 311).

30. A monolithic bicycle wheel spoke (10), the spoke extending along a longitudinal axis (X-X) and comprising:
a longitudinal axis X-X extending throughout the length of a spoke,
first and second end portions adapted for attachment to a hub (100) or a rim (402) of a bicycle wheel;
an intermediate portion (50) between said first and second end portions, that is flattened in a direction (Z) that is perpendicular to said longitudinal axis (X-X); and
at least one of said end portions having a head for attachment that has a surface of revolution (310, 320) with at least one discontinuity (70, 75, 311).

31. A bicycle wheel spoke (10) comprising:
an elongated body (20) extending along a longitudinal axis (X-X);
first and second end portions, at least one of said first and second end portions having a head for attachment to a hub (100) or a rim (402) of a bicycle wheel;
an intermediate portion (50) between said first and second end portions, that is flattened in a direction (Z) perpendicular to said longitudinal axis (X-X); and
said head has a surface of revolution (310, 320) with at least one discontinuity (70, 75, 311);
wherein said surface of revolution (310, 320) is defined on an element distinct from said elongated body (20) and associated with said elongated body (20) at least one of said first and second end portions (30, 40).

32. A spoke (10) for a bicycle wheel, the spoke extending along a longitudinal axis (X-X) and comprising:
an elongated body (20) having a first end (30) for attachment to a hub (100) of a bicycle wheel and a second end (40) for attachment to a rim (402) of a bicycle wheel (400);
an intermediate portion (50) of the elongated body between said first and second ends is configured to have a cross section perpendicular to the axis (X-X) and with a long (Y) and short dimension (Z); and
at least one of said first and second ends (30, 40) includes a positioning element that is located to position the spoke in the bicycle wheel with the long dimension (Y) of the intermediate portion (50) extending parallel to a face plane (P-P) of the wheel (400).

33. A spoke (10) for a bicycle wheel, the spoke comprising:
an elongated body (20) having first and second ends (30, 40) for attachment of the spoke between a wheel hub (100) and a wheel rim (402);
an intermediate portion (50) of the elongated body between said first and second ends has a cross section with long (Y) and short (Z) dimensions; and
at least one of the first and second ends (30, 40) is associated with a positioning element that positions the spoke in the bicycle wheel with the long dimension (Y) of the intermediate portion (50) oriented in desired direction with respect to the wheel's direction of travel.

34. A bicycle wheel (400) comprising:
a hub (100);
a rim (402);
a plurality of spokes, each of which has:
an elongated body (20) with first and second ends (30, 40) for attachment to a respective one of the wheel hub (100) and wheel rim (402);
a portion (50) of the elongated body has a cross section with long (Y) and short (Z) dimensions; and,
a discontinuity that positions the spoke in a bicycle wheel with the long dimension (Y) oriented in a desired direction with respect to the wheel's direction of travel as it rotates about the wheel hub (100).

35. The bicycle wheel of claim 32 wherein the hub (100) includes a complement to the discontinuity and the orientation of the spoke is determined by the complement's position in the hub (100).

36. The bicycle wheel of claim 32 wherein the rim (402) includes a complement to the discontinuity and the orientation of the spoke is determined by the complement's position in the rim (402).

37. A bicycle wheel (400) comprising:
a hub (100);
a rim (402);
a plurality of spokes, each of which has:
an elongated body (20) with first and second ends (30, 40) for attachment to a respective one of the wheel hub (100) and wheel rim (402); and,
at least a portion of the spoke (10) has a cross section with long (Y) and short (Z) dimensions; and,
a geometric element that positions the spoke in a bicycle wheel with the long dimension (Y) oriented in a desired direction with respect to the wheel's direction of travel.

38. The bicycle wheel of claim 37 wherein the hub (100) includes a complementary geometric element and the orientation of each of the spokes is determined by its position in the hub (100).

39. The bicycle wheel of claim 37 wherein the rim (402) includes a complementary geometric element and the orientation of each spoke is determined by its position in the rim (402).
